(19) United States
(12) Patent Application Publication
(10) Pub. No.: US 2026/0084488 A1
(43) Pub. Date: Mar. 26, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Yeonho Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 18/952,449

(22) Filed: Nov. 19, 2024

(30) Foreign Application Priority Data
Sep. 24, 2024 (KR) 10-2024-0128971

(51) Int. Cl. B60H 1/00

(52) U.S. Cl. CPC B60H 1/00907

(57) ABSTRACT

A heat pump system for a vehicle may include an ejector configured to increase the pressure of the introduced refrigerant and discharge the refrigerant with the increased pressure to increase the pressure and flow amount of the refrigerant, thereby being capable of decreasing the refrigerant load of the compressor by reducing the compression ratio of the compressor, and reducing the cooling load and improving the cooling performance.

### CROSS-REFERENCE TO RELATED APPLICATION

This application claims priority to and the benefit of Korean Patent Application No. 10-2024-0128971, filed in the Korean Intellectual Property Office on Sep. 24, 2024, the entire contents of which are incorporated herein by reference.

### BACKGROUND

### (a) Field

The present disclosure relates to a heat pump system for a vehicle. More particularly, the present disclosure relates to a heat pump system for a vehicle capable of reducing the cooling load and improving the cooling performance.

### (b) Description of the Related Art

Generally, an air conditioning system for a vehicle includes an air conditioner unit circulating a refrigerant in order to heat or cool an interior of the vehicle.

The air conditioner unit, which is used to maintain the interior of the vehicle at an appropriate temperature regardless of a change in an external temperature, is configured to heat or cool the interior of the vehicle by heat-exchange using a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and humidity of the interior of the vehicle by condensing a high-temperature high-pressure gas-phase refrigerant compressed from the compressor by the condenser, passing the refrigerant through the receiver drier and the expansion valve, and then evaporating the refrigerant in the evaporator in a cooling mode.

Recently, in accordance with a continuously increased interest in energy efficiency and environmental pollution, the development of an environmentally-friendly vehicle capable of substantially substituting for an internal combustion engine vehicle is desired. Environmentally-friendly vehicles are classified into electric vehicles driven using a fuel cell or electricity as a power source and hybrid vehicles driven using an engine and a battery.

Among these environmentally-friendly vehicles, a separate heater is not used unlike an air conditioner of a general vehicle. An air conditioner used in the environmentally-friendly vehicles is generally called a heat pump system.

The electric vehicles driven by the power source of the fuel cell generates driving force by converting chemical reaction energy between oxygen and hydrogen into electrical energy. In this process, heat energy is generated by a chemical reaction in a fuel cell. Therefore, it is desired to secure performance of the fuel cell by effectively removing the generated heat.

In addition, the hybrid vehicle generates driving force by driving a motor using electricity supplied from the fuel cell described above or an electrical battery, together with an engine operated by a fossil fuel. Therefore, heat generated from the fuel cell or the battery and the motor should be effectively removed in order to secure performance of the motor.

In such a conventional heat pump system, the refrigerant supplied from the compressor may be condensed while passing through the condenser. Accordingly, a pressure decrease of the refrigerant may occur at the outlet side of the condenser, and as a result, an overall flow amount of the refrigerant discharged from the condenser may decrease.

When the overall flow amount of the refrigerant discharged from the condenser decreases, since only a small flow amount of the refrigerant may be introduced into the evaporator, it is difficult to constantly maintain the temperature distribution of the evaporator, and the overall cooling performance and efficiency may be lowered.

In order to prevent such drawback, the pressure of the refrigerant supplied from the compressor may be increased by the amount of the decreased pressure, which leads to an excessive increase in the compressor's power consumption and results in higher overall power consumption due to the increase of the overall cooling load.

The above information disclosed in this Background section is only provided to enhance understanding of the background of the present disclosure, and therefore it may contain information that does not form the prior art that is already known to a person of ordinary skill in the art.

### SUMMARY

The present disclosure provides a heat pump system for a vehicle that applies an ejector configured to increase the pressure of the introduced refrigerant and discharge the refrigerant with the increased pressure to increase the pressure and flow amount of the refrigerant, thereby being capable of decreasing the refrigerant load of the compressor by reducing the compression ratio of the compressor, and reducing the cooling load and improving the cooling performance.

The present disclosure also provides a heat pump system for a vehicle capable of substantially reducing or minimizing the power consumption by decreasing the power consumption of the compressor.

In one embodiment, a heat pump system for a vehicle may include: a compressor configured to compress a refrigerant, a vehicle interior condenser connected to the compressor through a refrigerant line, and a heat-exchanger connected to the vehicle interior condenser through the refrigerant line, and configured to condense or evaporate the refrigerant by heat-exchanging the supplied refrigerant with an ambient air. The heat pump system further includes: a first expansion valve connected to the heat-exchanger through the refrigerant line, an evaporator connected to the first expansion valve through the refrigerant line, and configured to evaporate the refrigerant by heat-exchanging the supplied refrigerant with the ambient air, a first connection line that includes a first end connected to the refrigerant line at a downstream end of the evaporator and a second end connected to the refrigerant line between the heat-exchanger and the first expansion valve. The heat pump system further includes: a chiller disposed on the first connection line and configured to adjust a temperature of the coolant by heat-exchanging the refrigerant introduced into the first connection line with a selectively introduced coolant, and a second expansion valve disposed on the first connection line at an upstream end of the chiller. The heat pump system further includes: an ejector disposed on the refrigerant line between the evaporator and the compressor and configured to discharge the refrigerant at a pressure greater than a pressure of the introduced refrigerant; and a second connection line that includes a first end connected to the ejector, and a second end connected to the refrigerant line between the heat-exchanger and the first expansion valve.

The refrigerant discharged from at least one of the evaporator or the chiller may be introduced into the ejector through the refrigerant line, and the refrigerant discharged from the heat-exchanger may be introduced into the ejector through the second connection line.

A heat pump system for a vehicle may further include an accumulator disposed on the refrigerant line between the evaporator and the compressor, and a third expansion valve disposed on the refrigerant line between the vehicle interior condenser and the heat-exchanger.

The third expansion valve may be configured to, in a cooling mode of the vehicle interior, supply the refrigerant supplied from the vehicle interior condenser to the heat-exchanger without expansion, and in a heating mode of the vehicle interior, expand the refrigerant supplied from the vehicle interior condenser and supply the expanded refrigerant to the heat-exchanger.

A heat pump system for a vehicle may further include: a valve disposed on the refrigerant line between the heat-exchanger and the second end of the second connection line; and a third connection line that includes a first end connected to the valve, and a second end connected to the accumulator.

The valve may be a 3-way valve capable of distributing flow amounts and controlling the flow of the supplied refrigerant.

In a heating mode or a heating and dehumidifying mode of the vehicle interior, the third connection line may be selectively opened by an operation of the valve.

When the ejector is operated and cooling of a battery module is required in a cooling mode of the vehicle interior, the first connection line may be opened by an operation of the second expansion valve, the second connection line may be opened, the third connection line may be closed by an operation of the valve, a partial refrigerant among the refrigerant having passed through the heat-exchanger may flow to the refrigerant line, a remaining refrigerant among the refrigerant having passed through the heat-exchanger may flow to the second connection line, the refrigerant having passed through the evaporator and the chiller may be introduced into the ejector along the refrigerant line, the first expansion valve may be configured to expand the refrigerant introduced through the refrigerant line, and supply the expanded refrigerant to the evaporator, the second expansion valve may be configured to expand the refrigerant introduced through the first connection line, and supply the expanded refrigerant to the chiller, the third expansion valve may be configured to supply the refrigerant introduced through the refrigerant line to the heat-exchanger without expansion, and the ejector may be configured to supply the refrigerant introduced through the refrigerant line after passing through the evaporator and the chiller, respectively, and the refrigerant introduced through the second connection line, to the accumulator through the refrigerant line.

In a heating mode of the vehicle interior, the refrigerant line connecting the valve and the first expansion valve may be closed by an operation of the valve, the refrigerant line connecting the evaporator and the ejector may be closed, the refrigerant line connecting the ejector and the accumulator may be closed, the first connection line may be closed by the second expansion valve, the second connection line may be closed, the third connection line may be opened by the operation of the valve, operations of the first expansion valve and the second expansion valve may be stopped, the third expansion valve may be configured to expand the refrigerant introduced from the vehicle interior condenser and supply the expanded refrigerant to the heat-exchanger, and the ejector may stop operating.

The first expansion valve, the second expansion valve, and the third expansion valve may be 2-way electronic expansion valves configured to selectively expand the refrigerant while controlling a flowing movement of the supplied refrigerant.

A heat pump system for a vehicle may further include a sub-heat-exchanger connected to the refrigerant line connecting the heat-exchanger and the first expansion valve, and the refrigerant line connecting the ejector and the compressor, respectively.

The sub-heat-exchanger may be configured to heat-exchange the refrigerant supplied from the heat-exchanger through the refrigerant line, and the refrigerant supplied from the ejector, with each other.

A heat pump system for a vehicle may further include a battery module, through which the coolant circulates, where the chiller is connected to the battery module through a coolant line through which the coolant circulates.

When the battery module is to be cooled in a cooling mode of the vehicle interior, or when a waste heat of the battery module is to be recollected in a heating mode of the vehicle interior, the coolant line may be opened to connect the chiller and the battery module.

As described above, according to a heat pump system for a vehicle according to an embodiment, by applying an ejector configured to increase the pressure of the introduced refrigerant and discharge the refrigerant with the increased pressure to increase the pressure and flow amount of the refrigerant, the refrigerant load of the compressor may be decreased by reducing the compression ratio of the compressor, and reduction of the cooling load and improvement of the cooling performance may be achieved.

In addition, the present disclosure may minimize the power consumption by decreasing the power consumption of the compressor, and by employing a sub-heat-exchanger on the outlet side of the ejector, may control the overheating degree of the refrigerant introduced into the compressor, and may secure the stability of the entire system.

### BRIEF DESCRIPTION OF THE DRAWINGS

FIG. 1 is a block diagram of a heat pump system for a vehicle according to an embodiment.

FIG. 2 is an operation diagram of a heat pump system for a vehicle according to an embodiment, illustrating the operation state when the injector is operated and the battery module is cooled in the cooling mode of the vehicle interior.

FIG. 3 is an operation diagram of a heat pump system for a vehicle according to an embodiment, illustrating the heating mode of the vehicle interior.

### DETAILED DESCRIPTION

Some embodiments of the present disclosure are hereinafter be described in detail with reference to the accompanying drawings.

It should be understood that the embodiments described in the present disclosure and the configurations illustrated in the drawings are merely exemplary in nature and may not represent all of the technical ideas of the present disclosure, and therefore, there may be various equivalents and modified examples that can replace them at the time of filing this application.

In order to clarify the present disclosure, parts that are not related to the description are omitted, and the same elements or equivalents are referred to with the same reference numerals throughout the specification.

Also, the size and thickness of each element may be arbitrarily shown in the drawings, and the present disclosure is not necessarily limited thereto. Further, in the drawings, the thickness of layers, films, panels, regions, etc., may be exaggerated for clarity.

In addition, unless explicitly described to the contrary, the term “comprise” and variations thereof, such as “comprises” or “comprising”, should be understood to imply the inclusion of stated elements but not the exclusion of any other elements. The same is true for terms such as “have,” “include,” and the like. When a component, device, element, or the like of the present disclosure is described as having a purpose or performing an operation, function, or the like, the component, device, or element should be considered herein as being “configured to” meet that purpose or to perform that operation or function.

Furthermore, terms, such as “. . . unit”, “. . . means”, “. . . portions”, “. . . part”, and “. . . member” described in the specification, mean a unit of a comprehensive element that performs at least one function or operation. The refrigerant line disclosed and described herein may be referred to in sections or portions, such as first refrigerant line, second refrigerant line, etc. to distinguish segments of the refrigerant line that may be described as being disposed between various parts and components of the system.

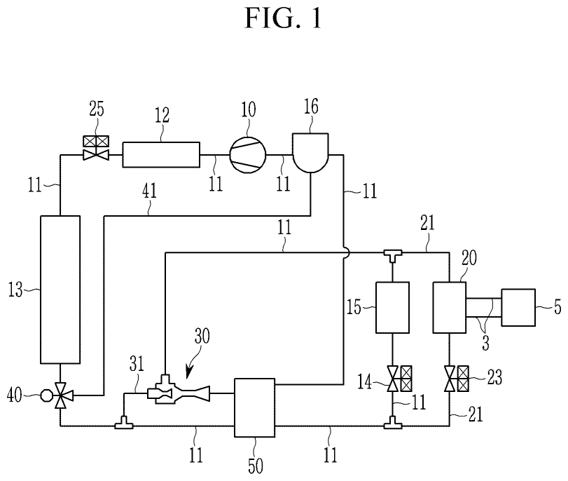

FIG. 1 is a block diagram of a heat pump system for a vehicle according to an embodiment.

According to an embodiment, by applying an ejector 30 configured to increase a pressure of an introduced refrigerant and discharge the refrigerant with the increased pressure, a heat pump system for a vehicle may increase the pressure and flow amount of the refrigerant, thereby reducing the compression ratio and refrigerant load of the compressor 10, as well as reducing the cooling load and improving the cooling performance.

Here, according to the heat pump system for an electric vehicle, a cooling apparatus through which a coolant circulates and an air conditioner unit, which is an air-conditioner apparatus through which the refrigerant circulates for cooling and heating the vehicle interior, may be interconnected with each other.

In other words, referring to FIG. 1, the heat pump system may include the cooling apparatus, and the air conditioner unit provided with a compressor 10, a vehicle interior condenser 12, a heat-exchanger 13, a first expansion valve 14, an evaporator 15, a chiller 20, a first connection line 21, a second expansion valve 23, an ejector 30, and a second connection line 31.

In one embodiment, the cooling apparatus may include a battery module 5 through which the coolant circulates.

The cooling apparatus may further include a radiator (not shown). The radiator may be disposed in a frontal region of the vehicle. A cooling fan (not shown) may be provided at a rear of the radiator. Accordingly, the radiator may cool the coolant through an operation of the cooling fan and exchanging heat with an ambient air.

The battery module 5 may be connected to the chiller 20 through a coolant line 3 through which the coolant circulates.

In other words, the battery module 5 may be connected to the coolant line 3, and may be water-cooled.

In other words, when the battery module 5 is to be cooled in a cooling mode of the vehicle interior, or when a waste heat of the battery module 5 is to be recollected in a heating mode of the vehicle interior, the coolant line 3 may be opened to connect the chiller 20 and the battery module 5.

Here, the coolant may selectively circulate through the coolant line 3 by a water pump (not shown).

In the present embodiment, the compressor 10 may compress the supplied refrigerant and flow the compressed refrigerant to the refrigerant line 11 such that the refrigerant may circulate along a refrigerant line 11.

The vehicle interior condenser 12 may be connected to the compressor 10 through the refrigerant line 11. The vehicle interior condenser 12 may be provided inside a HVAC module (not shown).

In the present embodiment, the heat-exchanger 13 may be connected to the vehicle interior condenser 12 through the refrigerant line 11. The heat-exchanger 13 may be disposed in the frontal region of the vehicle.

Accordingly, the heat-exchanger 13 may condense or evaporate the refrigerant by exchanging heat between the introduced refrigerant and the ambient air introduced while the vehicle is running. In other words, the heat-exchanger 13 may be an air-cooled heat-exchanger configured to exchange heat between the introduced refrigerant and the ambient air.

The first expansion valve 14 may be provided in the heat-exchanger 13 and the refrigerant line 11. The first expansion valve 14 may selectively expand the introduced refrigerant.

In the present embodiment, the evaporator 15 may be connected to the first expansion valve 14 through the refrigerant line 11.

The evaporator 15 may be provided inside the HVAC module (not shown). Here, the evaporator 15 may evaporate the refrigerant by exchanging heat between the supplied refrigerant and the ambient air.

Here, an opening/closing door (not shown) configured to adjust the ambient air having passed through the evaporator 15 to be selectively introduced into the vehicle interior condenser 12 may be provided inside the HVAC module between the evaporator 15 and the vehicle interior condenser 12.

At the time of heating the vehicle interior, the opening/closing door may be opened such that the ambient air having passed through the evaporator 15 may be introduced into the vehicle interior condenser 12.

In other words, a high-temperature refrigerant supplied to the vehicle interior condenser 12 may increase the temperature of the ambient air passing through the vehicle interior condenser 12. The introduced ambient air may be converted into a high-temperature state while passing through the vehicle interior condenser 12, and then introduced into the vehicle interior, thereby implementing heating of the vehicle interior.

To the contrary, at the time of cooling the vehicle interior, the opening/closing door may close a side toward the vehicle interior condenser 12 such that the ambient air that has been cooled while passing through the evaporator 15 may be directly introduced into the vehicle.

Accordingly, the ambient air passing through the evaporator 15 may be cooled by the low-temperature refrigerant supplied to the evaporator 15 while passing through the evaporator 15. The cooled ambient air may be introduced into the vehicle interior, thereby cooling the vehicle interior.

In another embodiment, the air conditioner unit may further include an accumulator 16. The accumulator 16 may be provided on the refrigerant line 11 between the evaporator 15 and the compressor 10.

The accumulator 16 may improve the efficiency and durability of the compressor 10 by supplying only the gaseous refrigerant to the compressor 10.

In the present embodiment, the chiller 20 may adjust the temperature of the coolant selectively supplied through the coolant line 3 by exchanging heat between the refrigerant supplied from the air conditioner unit and the coolant.

In other words, the chiller 20 may be a water-cooled heat-exchanger configured to exchange heat between the interiorly introduced refrigerant and the coolant.

Here, the chiller 20 may be connected to the refrigerant line 11 through the first connection line 21.

A first end of the first connection line 21 may be connected to the refrigerant line 11 at a downstream end of the evaporator 15. A second end of the first connection line 21 may be connected to the refrigerant line 11 between the heat-exchanger 13 and the first expansion valve 14.

The chiller 20 may adjust the temperature of the coolant by exchanging heat between the coolant that is selectively introduced through the coolant line 3 and the refrigerant that is selectively supplied from the air conditioner unit.

Accordingly, the coolant heat-exchanged with the refrigerant at the chiller 20 may be selectively supplied to the battery module 5, to adjust a temperature of the battery module 5.

The chiller 20 configured as such may be disposed in parallel to the heat-exchanger 13 and the evaporator 15 through the first connection line 21.

In the present embodiment, the second expansion valve 23 may be provided on the first connection line 21 at an upstream end of the chiller 20.

Here, when the battery module 5 is to be cooled by the coolant that has exchanged heat with the refrigerant in the cooling mode of the vehicle interior, the second expansion valve 23 may expand the refrigerant introduced through the first connection line 21 and flow the expanded refrigerant to the chiller 20.

In other words, when the battery module 5 is to be cooled in the cooling mode of the vehicle interior, the second expansion valve 23 may further lower temperature of the coolant passing through an interior of the chiller 20 by expanding the refrigerant introduced into the first connection line 21 to lower its temperature, and then directing the expanded refrigerant to the chiller 20.

Accordingly, the coolant whose temperature has been lowered while passing through the chiller 20 is introduced into the battery module 5, thereby achieving more efficient cooling.

When the waste heat generated from the battery module 5 is to be recollected in the heating mode of the vehicle interior, the second expansion valve 23 may expand the refrigerant introduced through the first connection line 21, and supply the expanded refrigerant to the chiller 20.

Accordingly, the chiller 20 may evaporate the refrigerant through heat-exchange with the coolant supplied through the coolant line 3.

Here, the chiller 20 may collect the waste heat of the battery module 5 while exchanging heat between the refrigerant supplied from the second expansion valve 23 and the coolant supplied from the battery module 5.

Here, the first expansion valve 14 and the second expansion valve 23 may be 2-way electronic expansion valves configured to selectively expand the refrigerant while controlling a flowing movement of the supplied refrigerant. The 2-way electronic expansion valve may have one inlet and one outlet.

Here, the upstream end of the chiller 20 may be set based on a flow direction of the refrigerant. Based on a direction in which the refrigerant flows along the first connection line 21, a location at which the refrigerant is introduced into the chiller 20 may be defined as the upstream end of the chiller 20, and a location at which the refrigerant is discharged from the chiller 20 may be defined as a downstream end of the chiller 20.

In the present embodiment, the ejector 30 may be provided on the refrigerant line 11 between the evaporator 15 and the compressor 10. The ejector 30 may discharge the refrigerant at a pressure greater than the introduced pressure of the refrigerant.

A first end of the second connection line 31 may be connected to the ejector 30. A second end of the second connection line 31 may be connected to the refrigerant line 11 between the heat-exchanger 13 and the first expansion valve 14.

Here, the refrigerant discharged from at least one or all of the evaporator 15 and the chiller 20 may be introduced into the ejector 30 through the refrigerant line 11.

Simultaneously, the refrigerant discharged from the heat-exchanger 13 may be introduced into the ejector 30 through the second connection line 31.

The ejector 30 may mix the refrigerant discharged from at least one or all of the evaporator 15 and the chiller 20, and the refrigerant discharged from the heat-exchanger 13, and may discharge the mixed refrigerant to the refrigerant line 11.

In more detail, the refrigerant discharged from at least one or all of the evaporator 15 and the chiller 20, and the refrigerant discharged from the heat-exchanger 13 may be completely mixed while passing through an interior of the ejector 30, and may be discharged to the accumulator 16 through the refrigerant line 11, in a state with increased flow speed and flow amount.

Here, the interior of the ejector 30 may be formed in a venturi tube shape. In addition, the ejector 30 may be formed such that the diameter of the discharge hole through which the refrigerant is discharged is smaller than the diameter of the inlet hole through which the refrigerant is introduced.

Accordingly, the pressure of the refrigerant discharged by passing through the ejector 30 may be greater than the pressure of the introduced refrigerant.

The ejector 30 may increase the flow amount (or flow rate) of the refrigerant by mixing the refrigerant, which has a reduced pressure after passing through the heat-exchanger 13, with the refrigerant supplied from at least one or both of the evaporator 15 and the chiller 20.

Simultaneously, the ejector 30 may increase the pressure of the refrigerant and discharge the refrigerant at the increased pressure by passing the refrigerant, with the increased flow amount (or flow rate), through a venturi tube-shaped interior.

Through this operation, the ejector 30 may minimize the decrease in the pressure and flow amount of the refrigerant circulating the refrigerant line 11, and may constantly maintain the flow amount of the refrigerant.

In other words, by using the ejector 30 in order to prevent the flow amount of the refrigerant circulating the refrigerant line 11 from decreasing, the heat pump system may prevent the pressure and flow amount of the refrigerant from being decreased, without increasing the required torque of the compressor 10.

In addition, the heat pump system may reduce the compression ratio of the compressor 10 by using the ejector 30 and decrease the refrigerant load of the compressor 10.

In another embodiment, the heat pump system may further include a third expansion valve 25, a valve 40, and a third connection line 41.

The third expansion valve 25 may be provided on the refrigerant line 11 between the vehicle interior condenser 12 and the heat-exchanger 13.

The third expansion valve 25 may selectively expand the refrigerant supplied from the vehicle interior condenser 12 through the refrigerant line 11, and then supply the expanded refrigerant to the heat-exchanger 13.

The third expansion valve 25 may be a 2-way electronic expansion valve configured to selectively expand the refrigerant while controlling the flowing movement of the supplied refrigerant. The 2-way electronic expansion valve may have one inlet and one outlet.

In the cooling mode of the vehicle interior, the third expansion valve 25 configured as such may supply the refrigerant supplied from the vehicle interior condenser 12 to the heat-exchanger 13 without expansion. Here, the heat-exchanger 13 may condense the introduced refrigerant through heat-exchange with the ambient air introduced while the vehicle is running.

On the other hand, in the heating mode of the vehicle interior, the third expansion valve 25 may expand the refrigerant supplied from the vehicle interior condenser 12 and supply the expanded refrigerant to the heat-exchanger 13. Here, the heat-exchanger 13 may evaporate the introduced refrigerant through heat-exchange with the ambient air introduced while the vehicle is running.

In the present embodiment, the valve 40 may be provided on the refrigerant line 11 between the heat-exchanger 13 and the second end of the second connection line 31.

Here, the valve 40 may be a 3-way valve capable of distributing flow amounts and controlling the flow of the supplied refrigerant.

In addition, a first end of the third connection line 41 may be connected to the valve 40. A second end of the third connection line 41 may be connected to the accumulator 16.

The third connection line 41 configured as such may be selectively opened by an operation of the valve 40, in the heating mode or the heating and dehumidifying mode of the vehicle interior.

In another embodiment, the heat pump system may further include a sub-heat-exchanger 50.

The sub-heat-exchanger 50 may be connected to the refrigerant line 11 connecting the heat-exchanger 13 and the first expansion valve 14, and the refrigerant line 11 connecting the ejector 30 and the compressor 10, respectively.

The sub-heat-exchanger 50 may exchange heat between the refrigerant supplied from the heat-exchanger 13 through the refrigerant line 11 and the refrigerant supplied from the ejector 30, with each other.

Here, the sub-heat-exchanger 50 may be a double-tube heat-exchanger that exchanges heat between refrigerants having different temperatures.

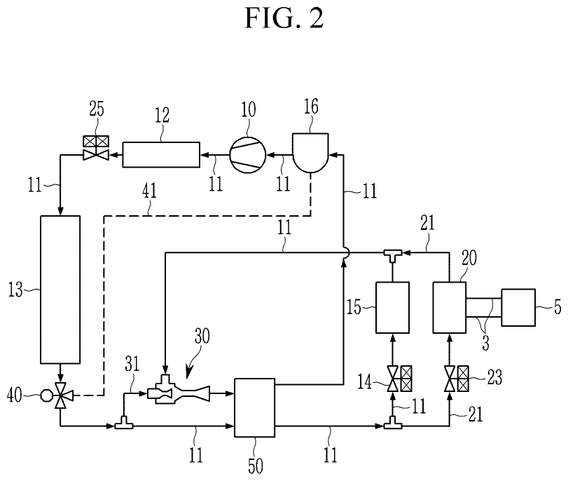

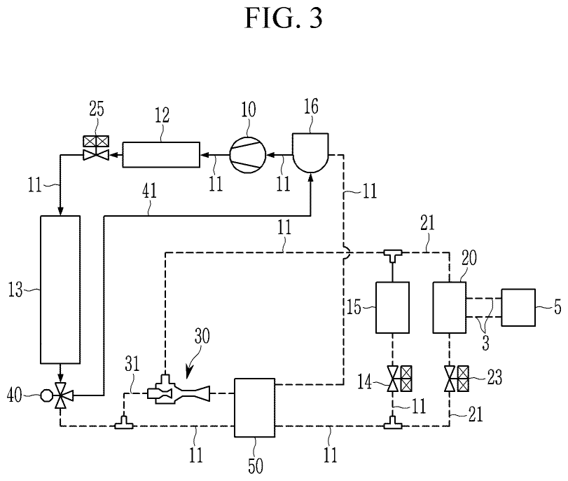

An operation and action of the heat pump system according to an embodiment configured are described in detail with reference to FIG. 2 and FIG. 3.

An operation in case that the ejector 30 of the heat pump system is operated and cooling of the battery module 5 is required in the cooling mode of the vehicle interior, according to an embodiment, is described with reference to FIG. 2.

FIG. 2 is an operation diagram of a heat pump system for a vehicle according to an embodiment, illustrating the operation state when the injector is operated, and the battery module is cooled in the cooling mode of the vehicle interior.

Referring to FIG. 2, the compressor 10 may be operated in order to cool the vehicle interior. The refrigerant line 11 may interconnect corresponding components such that the refrigerant discharged from the compressor 10 may circulate through the components along the refrigerant line 11.

Here, the third expansion valve 25 may supply the refrigerant introduced through the refrigerant line 11 to the heat-exchanger 13 without expansion. In this case, the heat-exchanger 13 may condense the refrigerant that is supplied from the third expansion valve 25 through heat-exchange with the ambient air.

In the present embodiment, the first connection line 21 may be opened by an operation of the second expansion valve 23. The second connection line 31 may be opened.

The third connection line 41 may be closed by the operation of the valve 40. Here, the valve 40 may operate such that the heat-exchanger 13 and the first expansion valve 14 may be connected to each other through the refrigerant line 11.

Accordingly, the refrigerant discharged from the heat-exchanger 13 may flow to the refrigerant line 11 and the second connection line 31.

Here, a partial refrigerant, among the refrigerant having passed through the heat-exchanger 13, may pass through the sub-heat-exchanger 50 along the refrigerant line 11. The sub-heat-exchanger 50 may additionally condense the refrigerant that has been discharged from the heat-exchanger 13 through heat-exchange with the refrigerant supplied from the ejector 30.

A partial refrigerant, among the refrigerant having passed through the sub-heat-exchanger 50, may be introduced into the first expansion valve 14 along the refrigerant line 11.

The first expansion valve 14 may expand the refrigerant introduced through the refrigerant line 11 and supply the expanded refrigerant to the evaporator 15.

Here, the ambient air introduced into the HVAC module may be cooled by the low-temperature refrigerant introduced into the evaporator 15 while passing through the evaporator 15.

At this time, the opening/closing door may close a passage of the vehicle interior condenser 12 such that the cooled ambient air may not pass through the vehicle interior condenser 12. Therefore, the cooled ambient air may cool the vehicle interior by being directly introduced into the vehicle interior.

In the present embodiment, a remaining refrigerant, among the refrigerant having passed through the sub-heat-exchanger 50, may be introduced into the second expansion valve 23 along the first connection line 21.

Here, the second expansion valve 23 may expand the refrigerant introduced through the first connection line 21. Thereafter, the second expansion valve 23 may supply the expanded refrigerant to the chiller 20 through the first connection line 21.

The refrigerant introduced into the chiller 20 may be heat-exchanged with the coolant supplied from the battery module 5 through the coolant line 3, and thereby may cool the coolant.

The coolant cooled at the chiller 20 may be supplied to the battery module 5 along the coolant line 3. Accordingly, the battery module 5 may be efficiently cooled by the coolant cooled at the chiller 20.

The coolant circulating through the coolant line 3 may efficiently cool the battery module 5 while repeatedly performing the above-described operation.

Meanwhile, a remaining refrigerant, among the refrigerant having passed through the heat-exchanger 13, may flow to the second connection line 31.

Simultaneously, the refrigerant having passed through the evaporator 15 and the chiller 20, respectively, may be introduced into the ejector 30 along the refrigerant line 11.

Here, the ejector 30 may receive the refrigerant introduced through the refrigerant line 11 after passing through the evaporator 15 and the chiller 20, respectively, and the refrigerant introduced through the second connection line 31, and then, the ejector 30 may increase the flow speed and flow amount and discharge the refrigerant with the increased flow speed and flow amount to the refrigerant line 11.

The refrigerant discharged from the ejector 30 to the refrigerant line 11 may be heat-exchanged with the refrigerant discharged from the heat-exchanger 13 while passing through the sub-heat-exchanger 50.

In addition, it may be supplied to the accumulator 16 along the refrigerant line 11. Thereafter, the refrigerant may pass through the accumulator 16, and flow into the compressor 10.

In other words, the refrigerant having the pressure and flow amount lowered while passing through the heat-exchanger 13 may have its pressure and flow amount increased by the ejector 30 and then be introduced into the compressor 10. The introduced refrigerant may be compressed by the compressor 10.

The refrigerant compressed at the compressor 10 may pass through the vehicle interior condenser 12, and then may be supplied to the third expansion valve 25 along the refrigerant line 11.

Then, the heat pump system may repeatedly perform the above-described processes.

By repeatedly performing the above-described operation, the heat pump system may minimize the decrease in the pressure and flow amount of the refrigerant flowing along the refrigerant line 11, and may constantly maintain the flow amount of the refrigerant.

In addition, in the cooling mode of the vehicle interior, the heat pump system may reduce the compression ratio of the compressor 10 to decrease the refrigerant load of the compressor 10, and thereby may reduce the overall cooling load and improve the cooling performance, and efficiently cool the vehicle interior.

Simultaneously, the heat pump system may efficiently cool the battery module 5 by using the low-temperature coolant cooled at the chiller 20.

An operation in the heating mode of the vehicle interior, using a heat pump system for a vehicle according to an embodiment, is described with reference to FIG. 3.

FIG. 3 is an operation diagram of a heat pump system for a vehicle according to an embodiment, for the heating mode of the vehicle interior.

Referring to FIG. 3, in the heating mode of the vehicle interior, the operation of the first expansion valve 14 may be stopped. Accordingly, a supply of the refrigerant to the evaporator 15 may be stopped.

In such a state, the refrigerant line 11 connecting the valve 40 and the first expansion valve 14 may be closed by the operation of the valve 40.

Simultaneously, the refrigerant line 11 connecting the evaporator 15 and the ejector 30 may be closed. In addition, the refrigerant line 11 connecting the ejector 30 and the accumulator 16 may be closed.

In the present embodiment, the first connection line 21 may be closed by the second expansion valve 23. Here, the operation of the second expansion valve 23 may be stopped.

The second connection line 31 may be closed. In addition, the third connection line 41 may be opened by the operation of the valve 40.

Accordingly, the refrigerant may not be introduced into the ejector 30. In other words, an operation of the ejector 30 may be stopped.

In such a state, when the compressor 10 is operated, the refrigerant discharged from the compressor 10 may pass through the vehicle interior condenser 12 along the refrigerant line 11, and then be introduced into the third expansion valve 25.

Here, the third expansion valve 25 may expand the refrigerant introduced from the vehicle interior condenser 12. Thereafter, the third expansion valve 25 may supply the expanded refrigerant to the heat-exchanger 13 through the refrigerant line 11.

At this time, the heat-exchanger 13 may evaporate the refrigerant supplied from the third expansion valve 25 through heat-exchange with the ambient air. Here, the refrigerant may directly absorb the ambient air heat source from the ambient air.

The refrigerant having passed through the heat-exchanger 13 may pass through the accumulator 16 along the opened third connection line 41, and then be supplied to the compressor 10.

The compressor 10 may compress the supplied refrigerant, and may discharge the compressed refrigerant to the refrigerant line 11.

Accordingly, the refrigerant compressed at the compressor 10 may be supplied to the vehicle interior condenser 12 along the refrigerant line 11. Here, the refrigerant supplied to the vehicle interior condenser 12 may increase the temperature of the ambient air introduced into the HVAC module.

The opening/closing door may be opened such that the ambient air introduced into the HVAC module and having passed through the evaporator 15 may pass through the vehicle interior condenser 12.

Accordingly, when passing through the evaporator 15 that is not supplied with the refrigerant, the ambient air introduced from the outside may be introduced at a room-temperature state, which has not been cooled. The introduced ambient air may be converted into the high-temperature state while passing through the vehicle interior condenser 12, and then introduced into the vehicle interior, thereby implementing heating of the vehicle interior.

As such, a heat pump system according to an embodiment can recollect the ambient air heat source by the heat-exchanger 13 while the vehicle is running, and thereby can improve the overall heating performance and efficiency.

In addition, according to the present disclosure, the heating efficiency and performance may be improved while minimizing the usage of a separate electric heater.

Therefore, as described above, when a heat pump system for a vehicle according to an embodiment is applied, by applying the ejector 30 configured to increase the pressure of the introduced refrigerant and discharge the refrigerant with the increased pressure to increase the pressure and flow amount of the refrigerant, the compression ratio of the compressor 10 may be reduced to decrease the refrigerant load of the compressor 10, and the cooling load and improve the cooling performance may be reduced.

In addition, the present disclosure the power consumption may be minimized by decreasing the power consumption of the compressor 10, and by employing the sub-heat-exchanger 50 on an outlet side of the ejector 30, the overheating degree of the refrigerant introduced into the compressor 10 may be controlled, thereby securing the stability of the entire system.

While this present disclosure has been described in connection with what is presently considered to be practical exemplary embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

10: compressor
11: refrigerant line
12: the vehicle interior condenser
13: heat-exchanger
14: first expansion valve
15: evaporator
16: accumulator
20: chiller
21: first connection line
23: second expansion valve
25: third expansion valve
30: ejector
31: second connection line
40: valve
41: third connection line

What is claimed is:

1. A heat pump system for a vehicle, comprising:
a compressor configured to compress a refrigerant;
a vehicle interior condenser connected to the compressor through a refrigerant line;
a heat-exchanger connected to the vehicle interior condenser through the refrigerant line, and configured to condense or evaporate the refrigerant by heat-exchanging the supplied refrigerant with an ambient air;
a first expansion valve connected to the heat-exchanger through the refrigerant line;
an evaporator connected to the first expansion valve through the refrigerant line, and configured to evaporate the refrigerant by heat-exchanging the supplied refrigerant with the ambient air;
a first connection line having a first end connected to the refrigerant line at a downstream end of the evaporator, and having a second end connected to the refrigerant line between the heat-exchanger and the first expansion valve;
a chiller disposed on the first connection line, the chiller configured to adjust a temperature of the coolant by heat-exchanging the refrigerant introduced into the first connection line with a selectively introduced coolant;
a second expansion valve disposed on the first connection line at an upstream end of the chiller;
an ejector disposed on the refrigerant line between the evaporator and the compressor, the ejector configured to discharge the refrigerant at a pressure greater than a pressure of the introduced refrigerant; and
a second connection line having a first end connected to the ejector, and having a second end connected to the refrigerant line between the heat-exchanger and the first expansion valve.

2. The heat pump system of claim 1, wherein:
the refrigerant discharged from at least one of the evaporator or the chiller is introduced into the ejector through the refrigerant line; and
the refrigerant discharged from the heat-exchanger is introduced into the ejector through the second connection line.

3. The heat pump system of claim 1, further comprising:
an accumulator disposed on the refrigerant line between the evaporator and the compressor; and
a third expansion valve disposed on the refrigerant line between the vehicle interior condenser and the heat-exchanger.

4. The heat pump system of claim 3, wherein the third expansion valve is configured to:
in a cooling mode of the vehicle interior, supply the refrigerant supplied from the vehicle interior condenser to the heat-exchanger without expansion; and
in a heating mode of the vehicle interior, expand the refrigerant supplied from the vehicle interior condenser and supply the expanded refrigerant to the heat-exchanger.

5. The heat pump system of claim 3, further comprising:
a valve disposed on the refrigerant line between the heat-exchanger and the second end of the second connection line; and
a third connection line having a first end connected to the valve, and having a second end connected to the accumulator.

6. The heat pump system of claim 5, wherein the valve is a 3-way valve configured to control flow amounts and a flow of the supplied refrigerant.

7. The heat pump system of claim 5, wherein, in a heating mode or a heating and dehumidifying mode of the vehicle interior, the third connection line is selectively opened by an operation of the valve.

8. The heat pump system of claim 5, wherein, when the ejector is operated and cooling of a battery module is required in a cooling mode of the vehicle interior:
the first connection line is opened by an operation of the second expansion valve;
the second connection line is opened;
the third connection line is closed by an operation of the valve;
a partial refrigerant among the refrigerant having passed through the heat-exchanger flows to the refrigerant line;
a remaining refrigerant among the refrigerant having passed through the heat-exchanger flows to the second connection line;
the refrigerant having passed through the evaporator and the chiller is introduced into the ejector along the refrigerant line;
the first expansion valve is configured to expand the refrigerant introduced through the refrigerant line, and supply the expanded refrigerant to the evaporator;
the second expansion valve is configured to expand the refrigerant introduced through the first connection line, and supply the expanded refrigerant to the chiller;
the third expansion valve is configured to supply the refrigerant introduced through the refrigerant line to the heat-exchanger without expansion; and
the ejector is configured to supply the refrigerant introduced through the refrigerant line after passing through the evaporator and the chiller, respectively, and the refrigerant introduced through the second connection line, to the accumulator through the refrigerant line.

9. The heat pump system of claim 5, wherein, in a heating mode of the vehicle interior:
the refrigerant line connecting the valve and the first expansion valve is closed by an operation of the valve;
the refrigerant line connecting the evaporator and the ejector is closed;
the refrigerant line connecting the ejector and the accumulator is closed;
the first connection line is closed by the second expansion valve;
the second connection line is closed;
the third connection line is opened by the operation of the valve;
operations of the first expansion valve and the second expansion valve are stopped;
the third expansion valve is configured to expand the refrigerant introduced from the vehicle interior condenser and supply the expanded refrigerant to the heat-exchanger; and
the ejector stops operating.

10. The heat pump system of claim 3, wherein the first expansion valve, the second expansion valve, and the third expansion valve are 2-way electronic expansion valves configured to selectively expand the refrigerant while controlling a flowing movement of the supplied refrigerant.

11. The heat pump system of claim 1, further comprising a sub-heat-exchanger connected to the refrigerant line connecting the heat-exchanger and the first expansion valve, and the refrigerant line connecting the ejector and the compressor, respectively.

12. The heat pump system of claim 11, wherein the sub-heat-exchanger is configured to exchange heat between the refrigerant supplied from the heat-exchanger through the refrigerant line, and the refrigerant supplied from the ejector.

13. The heat pump system of claim 1, further comprising: a battery module through which the coolant circulates,
wherein the chiller is connected to the battery module through a coolant line through which the coolant circulates.

14. The heat pump system of claim 13, wherein, when the battery module is to be cooled in a cooling mode of the vehicle interior, or when a waste heat of the battery module is to be recollected in a heating mode of the vehicle interior, the coolant line is opened to connect the chiller and the battery module.
